(19) United States
(12) Patent Application Publication
(10) Pub. No.: US 2020/0085030 A1
(43) Pub. Date: Mar. 19, 2020

(54) BAIT STATION FOR CONTROLLING INSECTS SUCH AS YELLOW JACKETS

(71) Applicant: YJ AWAY, LLC, LAFAYETTE, CA (US)

(72) Inventor: CHARLES SPENCER GRAHAM, LAFAYETTE, CA (US)

(21) Appl. No.: 16/131,381

(22) Filed: Sep. 14, 2018

(51) Int. Cl. A01M 1/20; A01M 1/02

(52) U.S. Cl. CPC A01M 1/2016; A01M 1/02

(57) ABSTRACT

A bait station for controlling insects such as yellowjackets and other wasps includes a housing that is formed from bottom vessel where insecticide-laced bait is positioned, and a top portion having apertures or holes that is sealable to the bottom vessel and allows for entry and entry of insects to be controlled. A mixing top may be further included that is applicable to the bottom vessel and enables bait to be mixed inside the bottom vessel. The ingredients of the bait are placed into the bottom vessel, and the mixing top is attached and sealed to the bottom vessel, which is then shaken to mix the ingredients to evenly spread the insecticide across the bait and throughout an interior surface of the bottom vessel. The mixing top is removed and the separate top portion is sealed to the bottom vessel, forming the bait station which is deployed to attract insects. The insects enter the bait station and either grab bait or coat their bodies with bait, enabling a transfer of effective doses of slow-acting insecticide to their nests following exit from the bait station. A method of controlling insects also enables bait to be mixed together with an insecticide without transferring the treated bait to a different container, without external devices, and in a way that does not risk spills or splashes.

### CROSS-REFERENCE TO RELATED PATENT APPLICATIONS

None.

### FIELD OF THE INVENTION

The present invention relates to an apparatus for controlling insects. Specifically, the present invention relates to a bait station which attracts insects with one or more insecticide-laced baits composed of multiple ingredients that are mixed together within the bait station, and allows the insects to exit the bait station with the insecticide-laced bait and bring it to a remote nest.

### BACKGROUND OF THE INVENTION

There are many types of apparatuses, devices and products available that provide solutions to controlling aggressive, destructive, or other nuisance-causing insects, such as wasps that are commonly known as yellowjackets. Some of these solutions attempt to kill such insects by permanently trapping them in a container, but these solutions are limited because they will only kill insects that enter the container, which is a small percentage of the total population of an active nest. Such solutions, therefore, do not allow the insects to take a slow-acting bait back to the nest to destroy the nest's other occupants. Other solutions attempt to use particular insecticides or pesticides as bait, such as Esfenvalerate (a synthetic pyrethroid insecticide), but these solutions are similarly unable to meet industry needs because Esfenvalerate has not been shown to be effective with all insects, for example certain species of yellowjackets. Other existing solutions seek to kill insect nests using just a poisonous bait, but these solutions also are lacking because they rely on the insect grabbing the bait, and do not provide a method for getting poison onto insect bodies for a more robust distribution when back in the nest.

Still others seek to kill insects using a Fipronil-treated bait station, but these solutions also fail to meet industry needs because they rely on the owner to mix their own poisonous bait in a way that can cause spills and leaks, for example by having to transfer the bait into a bait station, risking pesticide contamination of the work or placement area. Others seek to kill yellow jackets using a treated bait station, but they fail to meet industry needs because they rely on the owner to stir their own baits in a way that can allow for uneven mixing of the pesticide in the bait. Additional solutions seek to kill yellow jackets using a treated bait station, but they fail to meet industry needs because they rely on the owner to mix their own baits with an external mixing stick, and insufficiently lace the sides of the bait station with insecticide/pesticide, allowing the wasp to leave without attaching delayed-acting poison to its appendages.

Current solutions to addressing these issues involve either guessing the best protein for the insect population to be controlled, or by testing, by placing different proteins in the open and seeing which one attracts the most insects. This can be time consuming and risky for the pest controller, as one must wait to see the results, and run the risk of getting stung while retrieving the extra food, and also the risk of having a wild animal or pet eat the food while running the experiment. Conversely, one may use their instinct and just pick a bait, but then there is the risk of having an ineffective bait station, and having to start over. Additionally, one must take care not to harm protected or endangered species, or cause damage to populations of insects that are not aggressive (or do not need to be controlled) or are otherwise environmentally sensitive, such as honey bees.

Therefore, there is a need unmet in the existing art for a system and method of controlling insects that deploys bait, comprised of a protein laced with slow-acting insecticide that is combined by shaking or otherwise mixing inside a container serving as a trap, that is attractive to particular insects and can be taken when they enter and leave the trap. There is an additional unmet need to deploy such an insecticide-laced bait onto the bodies of insects as they maneuver within the housing that contains the bait. There is a further need for approaches to preparing a treated bait for an insect bait station that prevents spills and transfer of insecticide-laced bait, preparing treated bait for a bait station that can uniformly mix the insecticide and bait, preparing bait for a bait station that does not require a risky transfer of the bait from a mixing container into a bait station container. There is a still a further unmet need for an approach which effectively targets an insect population without excessive testing or risk.

### BRIEF SUMMARY OF THE INVENTION

It is one objective of the present invention to provide an apparatus for attracting insects, such as yellow jackets, and enabling a transfer of effective doses of slow- acting insecticides and pesticides back to their nests with a bait laced with such a poison. It is another objective of the present invention to provide an apparatus that enables insects to easily enter a housing that includes an insecticide-laced bait and take portions of the bait back to their nests. It is still another objective of the present invention to be able to mix together an insecticide and a bait within a bait station itself in a way that does not risk spills or splashes of the poison that would contaminate the user or the surrounding environment. It is still another objective of the present invention to provide an apparatus where the insecticide is contained only on an inside of a housing, and not on the outside, so as not to contaminate the environment or pose a danger to the person arranging the apparatus for use.

It is a further objective of the present invention to provide a system and method of mixing an insecticide and a bait together, without having to transfer treated bait to a different container. It is still another objective of the present invention to provide an apparatus that is effective in getting slow-acting insecticide onto the exterior portions of bodies of insects such as their exoskeletons, allowing them to bring even more of insecticide back to the nest. It is yet another objective of the present invention to provide a system and method of mixing together an insecticide and a bait within a bait station without another device or tool, such as for example a stirring stick or a spoon, that may end up with poisonous residue thereon.

It is still another objective of the present invention to provide to be able to mix a concentrated insecticide and bait and water within a housing comprising a bait station in a way that can evenly spread the insecticide across the bait. It is still another objective of the present invention to mix together an insecticide and a bait within a bait station by simply adding the ingredients, closing the bait station, and shaking it to ensure even distribution of the insecticide on the bait and of the insecticide-laced bait throughout the housing comprising the bait station.

The present invention is an apparatus that serves as a bait station for attracting insects that one desires to control. The bait station includes a housing having interior and exterior portions and a plurality of different components, and ingress/egress points in the housing that allow insects to gain access to insecticide- laced bait positioned within the housing. This apparatus can be used to control the populations of insect nests remotely by allowing the insects to take insecticide-laced bait from the housing and bring insecticides back into the nest, poisoning the queen, larvae, foragers and other members of the nest environment.

The housing includes a mixing container that can be sealed and shaken, and a container top having one or more apertures or holes that serve as entry and exit points for the insects. The container top is configured so that the mixing container can be attached to it, inserted into it, or converted into it (by opening the entry and exit points). The housing may also include an attachment, such as string, that enables the bait station to hang from an external member. It should be noted that the bait station is designed in such a way to encourage insects to be attracted to the bait, enter into and fly around the inside of the housing, collect the insecticide-laced bait, and then exit the bait station alive to return to their nest.

The bait station contains, in one embodiment, three components: a top portion having the one or more apertures or holes, a mixing top without holes, and a bottom vessel. The bait is configured in one aspect of the present invention station by shaking bait components together inside the housing. In another embodiment, the bait station is comprised of a container where the one or more apertures or holes can be opened or closed by sliding components to allow entry and exit vis-a-vis the housing. In another embodiment, the bait station consists of a sealable mixing container that can be shaken and then unsealed and placed into a bait station that has apertures or holes for entry/egress. In still another embodiment, the bait station includes a container with apertures or holes for insect egress/exit sealed by material such as tape, plugs or punchable or peelable plastic. In such an embodiment, the bait is mixed in the container and the tape, plastic or plug is pulled to reveal the holes.

In one implementation of the present invention, the bait components are added to the bottom vessel to introduce the solution to the housing. Water or other liquid is first added, and then a concentrated insecticide, followed by a protein-based bait. In other implementations, these or other ingredients may be added in any order and in any quantity sufficient to attract desired insects. The housing is then closed by applying the mixing top, which may be a screw-top lid having threads that engage with opposing threads on the bottom vessel, or via any another closure mechanism for sealing the container. The bait station is then shaken vigorously, mixing the ingredients inside the housing, and allowing the interior surface of the housing to be coated with insecticide. A vessel configured with temporarily sealed entry and egress points may also be used to shake the ingredients without having to utilize a separate top, in another embodiment of the present invention.

The bait station is then configured to present exit/egress holes for the target insects. In one embodiment, the bait station mixing top is removed and a new top having apertures or holes for insect entry and egress is connected. In the embodiment where the bottom vessel is shaken to mix the bait ingredients without having to utilize a separate mixing top, tape or plastic, or cork or plugs may be removed from the housing to reveal entry/exit holes. In the embodiment where the portion with one or more apertures is an outer or larger-vessel, the mixing top is removed and the mixing inner vessel is placed into a larger vessel with the one or more apertures. Regardless, once the bait station has been configured to attract live insects such as yellowjackets, it contaminates them with slow-acting insecticides and allows them to return to their nest, so that the insecticide poisons the other occupants of the nest.

The present invention therefore provides an apparatus and method to deploy a bait station that allows a slow-acting insecticide to be transferred to the bodies of insects such as yellow jackets when they enter due to an attractive bait. The present invention also provides methods of preparing a bait for a bait station that prevents spills and transfer of insecticide-laced bait during mixing or deployment, preparing a bait for a bait station that permits uniformly mixing the insecticide and bait together by making it possible to shake the ingredients together, preparing bait for a bait station that does not require a risky transfer of the bait from a mixing container into a bait station container, and preparing bait for a bait station that is simpler and more efficient than tediously stirring ingredients together.

Other objects, embodiments, implementations, aspects, features and advantages of the present invention will become apparent from the following description of the embodiments, taken together with the accompanying drawings, which illustrate, by way of example, the principles of the invention.

### BRIEF DESCRIPTION OF THE SEVERAL VIEWS OF THE DRAWINGS

The accompanying drawings, which are incorporated in and constitute a part of this specification, illustrate several embodiments of the invention and together with the description, serve to explain the principles of the invention.

FIG. 1 is a perspective view of a portion of a bait station for controlling insects according to one embodiment of the present invention, with insecticide-laced bait being added thereto;

FIG. 2; is a perspective view of a portion of a bait station for controlling insects according to the embodiment of FIG. 1, with liquid being added to thereto;

FIG. 3 is a view of a portion of a bait station for controlling insects according to the embodiment of FIG. 1 being shaken, with a mixing cap applied, to mix ingredients added to thereto;

FIG. 4 is a perspective view of components a bait station for controlling insects according to the embodiment of FIG. 1;

FIG. 5 is a perspective view a bait station deployed for controlling insects according to the embodiment of FIG. 1;

FIG. 6 is a cross-section of a bait station for controlling insects according to the embodiment of FIG. 1; and

FIG. 7 is a cross-section of a portion of a housing of a bait station for controlling insects according to another embodiment of the present invention

### DETAILED DESCRIPTION OF THE INVENTION

In the following description of the present invention reference is made to the exemplary embodiments illustrating the principles of the present invention and how it is practiced. Other embodiments will be utilized to practice the present invention and structural and functional changes will be made thereto without departing from the scope of the present invention.

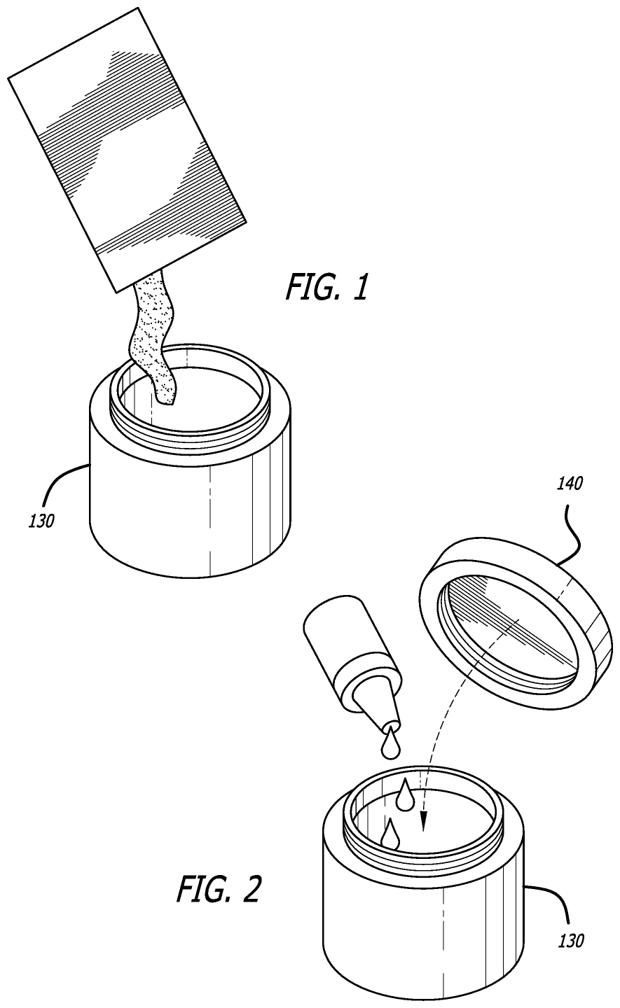

The present invention is a bait station 100 for controlling insects 102, such as yellowjackets and other wasps. FIGS. 1-5 show an exemplary configuration of such a bait station 100, in varying stages of preparation for deployment.

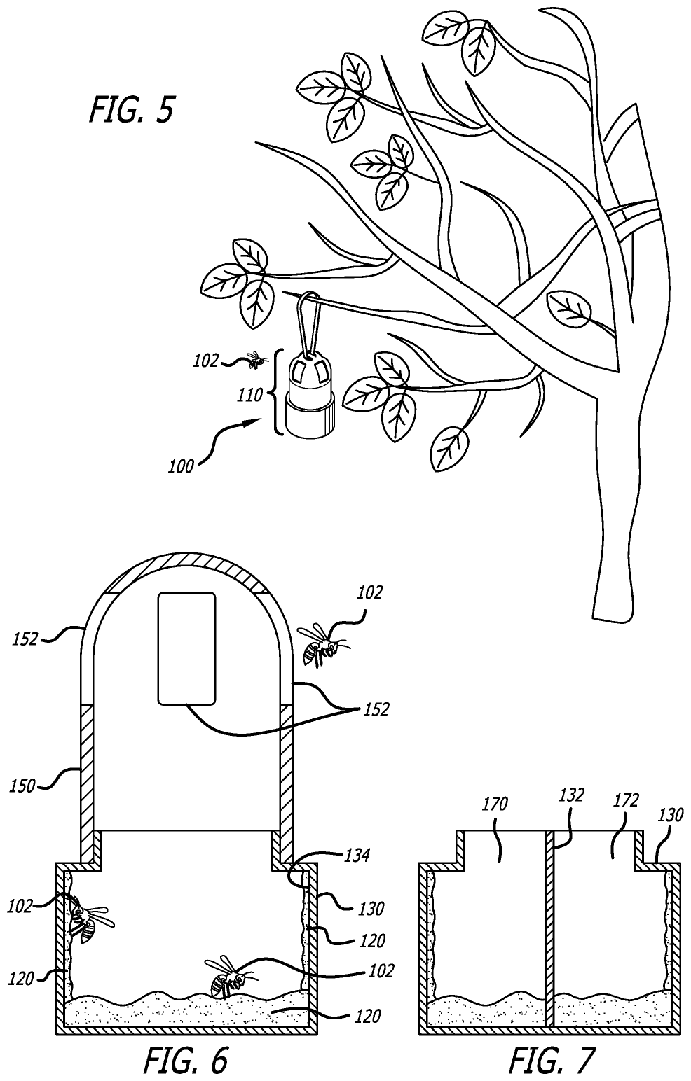

FIG. 4 and FIG. 5 are illustrations of the various structural elements of a bait station 100 according to one embodiment of the present invention. The bait station 100 includes a housing 110 within which insects 102 come into contact with an insecticide-laced bait 120. The bait station 100 includes a bottom vessel 130, and two removable top portions—a mixing cap 140, and an ingress and egress receptacle 150 having one or more apertures 152 that allow for insects 102 whose population are to be controlled to enter into and exit from the housing 110. Both the mixing cap 140 and the entry and egress portion 150 are capable of being sealed to the bottom vessel 130, so that they can be applied to and removed from the bottom vessel 130 when desired. When the ingress and egress receptacle 150 is applied to the bottom vessel 130, insects 102 entering the housing 110 through the one or more apertures 152 come into contact with the insecticide-laced bait 120, either by coating their exoskeletons or by grabbing the insecticide-laced bait or both, thereby taking portions of the insecticide-laced bait 120 with them after exiting the ingress and egress receptacle 150 through the apertures 152 back to their nests.

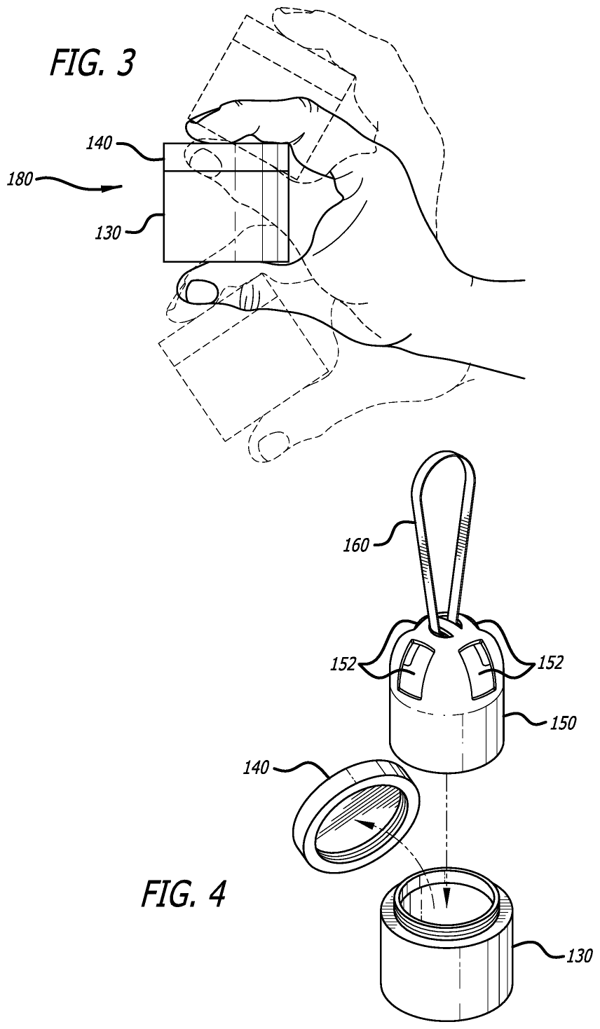

Because different types of insects 102 are attracted to different ingredients, it is to be understood that the insecticide-laced bait 120 may include many different components to produce bait that is effective, and that the present invention is not to be limited to any one composition of such a bait. Nevertheless, individual components for an effective insecticide-laced bait 120 in the present invention may generally include a pesticide concentrate (such as an insecticide or other poison), a bait, and a liquid such as water. As shown in FIG. 1 and FIG. 2, these ingredients are placed into the bottom vessel 130, and the mixing cap 140 may then be applied to the bottom vessel 130 to seal this portion of the housing 110. As shown in FIG. 3, the combination 180 of the bottom vessel 130 and the mixing cap 140 is then shaken to ensure that all ingredients of the bait 120 are mixed together. The mixing cap 140 is then removed, and a bait station cap comprising the ingress and egress receptacle 150 having holes allowing for entry and exit of insects 102 is attached onto the bottom vessel 130. Once sealed thereto, a full bait station 100 is created that allows insects to enter, come into contact with the treated bait 120, and exit. FIG. 5 illustrates a full bait station 100 deployed to attract insects 102. It should be understood that in this disclosure of the present invention, the poison may be either an insecticide or another form of pesticide, and that the words insecticide and pesticide may be used interchangeably herein.

This presents a unique solution to existing apparatuses that it is structurally different from other known solutions to attracting and controlling insects 102. More specifically, the present invention is novel due to the presence of a bottom, bait- holding vessel that is sealable to two versions of a top container—one that can used to close the bottom vessel for mixing bait therein, and one that can be applied to enable insect entry and egress to come into contact with mixed bait. The sealable bottom bait- holding vessel may be used to shake and mix bait without leakage or spills, and can also be attached to the top container having apertures or holes to build a complete insect bait station 100.

The present invention may further include one or more members 160 configured to suspend, hang or otherwise deploy the bait station 100 in a location as desired by a user. The one or more members 160 may include any components suitable for suspending or hanging the bait station 100, for example a wire string or elastic loop that can be fitted over a portion of a tree, such as a branch. It is to be understood nonetheless that the bait station 100 may be deployed in any manner, such as for example by placing it on a surface such as the ground, on a shelf or table, or hanging from nail, in any outdoor (or indoor) location where it is desirable to control insects 102.

It is to be noted that the bait station 100 may be configured to attract and poison any type of insect 102, aggressive, destructive or otherwise nuisance-causing, and therefore the present invention is not to be limited to any one type of insect 102 described herein. Therefore, while this disclosure mentions specifically wasps commonly known as “yellow jackets,” it is to be understood that the bait station 100 may be used to control populations of any type of insect 102 (or other pest) that a user desires to effect. For example, insects 102 may include, but are not limited to, hornets, termites, ants, or any other type of insect that whose population one desires to control.

It is to be further noted that many types of insecticide, many types of food, and many types of liquids may be used as ingredients so as to together comprise a bait 120. For example, and as noted above, the insecticide component may comprise one or more of Fipronil, Esfenvalerate, or any other chemical, synthetic, or naturally- occurring poison, or a mixture of any combination of them, in any amount. The present invention is not to be limited to any one insecticide, or combination or mixture amount(s) thereof that are discussed herein. Similarly, the food ingredient of the bait 120 may be raw or cooked chicken (or other type of poultry), raw or cooked fish (or other type of seafood), beef, lamb, venison or any other protein fat (natural or synthetic), or sugar-containing items, and may likewise be used in combination, in any amounts of each for such a mixture. The bait 120 may also be a non protein- based ingredient. The present invention is therefore also not to be limited to any one type of food, or combination or amount(s) thereof discussed herein. Further, in addition to the protein source, other additives and attractants may be added, such as to include, but not limited to, Heptyl Butyrate. In addition to the protein source, other additives may be added such as water-absorbing beads to address moisture. Further, in addition to or in lieu of water, any type of liquid may be used with the pesticide and food ingredients, again in any combination or mixture amount(s), and the present invention is not to be limited to any one type of liquid, or combination or mixture amount(s) thereof discussed herein.

In another embodiment, the present invention is a method of mixing ingredients for controlling a population of insects within a bait station 100. In this method, the individual ingredients for an effective bait 120 are placed into the bottom vessel 130, and the bottom vessel 130 is sealed using the mixing cap 140. The user then shakes or otherwise vigorously agitates the sealed bottom vessel 130 (as shown in FIG. 3) so that all ingredients are mixed together, causing insecticide to coat both the bait and the interior surface 134 of the bottom vessel 130. The mixing cap 140 is removed from the bottom vessel 130, and the ingress and egress receptacle 150, having therein one or more apertures or holes 152 for entry and exit of insects 102, is attached onto the bottom vessel 130 so that they are sealed thereto to form a bait station 100 that can be deployed as needed by the user. FIG. 6 illustrates a cross-section of a bait station 100, showing bait 120 inside the housing 110 and residue of the bait 120 on the interior surface 134 thereof.

The method of the present invention therefore provides an approach to preparing a bait station 100 for deployment that prevents spills and transfer of insecticide-laced bait 120 during the mixing process. The method also provides a way to prepare a bait station that involves uniformly mixing insecticide and bait 120 together, and a way to prepare a bait station 100 that does not require a risky transfer of treated bait 120 from a separate mixing container into the bait station 100. The method also provides an approach to preparing bait 120 for a bait station 100 that is simpler and more efficient than tediously stirring the ingredients together using an external device such as a stirring spoon.

The various components of the housing 110 forming the bait station 100 may be connectable to each in other in any way which permits a seal between so that the surrounding environment is not contaminated with insecticide, and so that a user does not come into contact with the insecticide, such as by spillage, leakage, or splashing. For example, the mixing cap 140 and ingress and egress receptacle 150 may both be attachable to the bottom vessel 130 using a threaded or screw mechanism, so that each component contains appropriate threads to engage with the other component. In such an example, the bottom vessel 130 may include threads on its outer surface, and the mixing cap 140 may include threads on its inner surface (and likewise with the ingress and egress receptacle 150), to form a sealed attachment when those threads are engaged with each other. In another example, the mixing cap 140 and ingress and egress receptacle 150 may be attachable to the bottom vessel 130 using a mechanism that allows them to tightly “snap” together. Additionally, multiple mechanisms may be used, so that each of the mixing cap 140 and ingress and egress receptacle 150 are attachable to the bottom vessel 130 in a different manner.

Additionally, the apertures and holes 152 in the ingress and egress receptacle 150 may be configured in different ways. For example, the apertures and holes 152 may have coverings, either using tape, plastic, cellophane, plugs, cork or some other method, and these coverings may be removable, such as by pulling or punching them out, once the bait station 100 is ready for deployment. In another example, the coverings of the apertures and holes 152 may also comprise sliding mechanisms, so that the covering is a piece that can simply be slid back into the housing 110 so as to be re-coverable when the bait station 100 is not in use, enabling the bait station 100 to be re-sealed and re-used as needed by the user. Additionally, the coverings of the apertures and holes 152 may provide the ability to place bait components into the same apertures and holes 152 used by insects 102 to enter and exit the bait station 100, so that the user simply needs to slide the coverings into place and shake the housing 110 after placing the ingredients therein. In this manner, interior surfaces 134 of both the bottom vessel 130 and the ingress and egress receptacle 150 may be covered with insecticide and/or insecticide-laced bait 120.

In a further example, the apertures and holes 152 in the ingress and egress receptacle 150 may be opened and closed using a twisting or snapping mechanism. In such an example, coverings are movable by twisting or snapping a portion on the outer surface of the ingress and egress receptacle 150. Additionally, these coverings may be opened and closed by twisting or snapping the ingress and egress receptacle 150 itself. This may be accomplished by twisting or turning or snapping either the entire ingress and egress receptacle 150, or a portion thereof.

The bait station 100 may also be configured so that a user can attach a top ingress and egress receptacle 150 having one or more apertures and holes 152 to a bottom vessel 130 that already contains pre-mixed bait. In such a configuration, the coverings of the one or more apertures and holes 152 in the ingress and egress receptacle 150 may be opened and closed by twisting at least a portion of the housing 110 (or other of the bottom vessel 130 or the ingress and egress receipt 150, or some other component of the housing 110) as suggested above.

Many other embodiments of the bait station 100 are possible and within the scope of the present invention. For example, the bait station 100 may also be configured so that a user may simply insert a container with pre-mixed bait into a housing comprised of the top ingress and egress receptacle 150 having one or more apertures and holes 152, and the bottom vessel 130.

As noted above, one issue with existing prior art bait station solutions is that different types of insects are attracted to different types of bait, and it is often difficult to discern what type of bait will work best for the type of insect the user would like to control. In one embodiment of the present invention, multiple variations (or different types) of bait 120 may be placed into the same bait station 100 at the same time. By including multiple types of bait 120 in the same housing 110, the same bait station 100 can attract multiple species of insects 102 (for example, different types of yellow jackets that are attracted to different types of bait 120).

In this embodiment, the bait station 100 enables multiple/distinct kinds of baits 120 (seafood-based bait, chicken-based bait, etc.) to be placed therein, separated in a way to allow insects 102 such as yellowjackets to be attracted to each bait 120. Exemplary methods of performing such separations include forming the housing 110 into two or more compartments, sections, or levels (illustrated in the cross-sectional view of the bottom vessel 130 in FIG. 7 as compartments 170 and 172) thereby allowing two or more different kinds of bait 120.

Insecticide-laced bait is not always taken back to the nests of insects, for several reasons. Insects may be attracted to the bait and enter the bait station, but may not grab the bait to take back to their nest. This may happen, for example, because the bait is too small, the insect has already eaten from another food source and is not as hungry, or because too many insects are already inside the bait station, resulting in aggressive behavior and departure without taking bait. As noted above, the present invention enables insecticide-laced residue from mixing the bait 120 (and some bait itself) to accumulate on the interior surface 134 of the housing 110, causing this residue to come into contact with the bodies or exoskeletons of insects 102. This residue remains on the insects 102 and is transferred back to their nests when they leave the bait station 100.

In another embodiment of the present invention, the amount of residue that accumulates on insect bodies in the bait station 100 and may be increased to improve the chances of insecticide being taken back to nests, by pre-coating the interior surface 134 of a housing 110 with a particular insecticide(s). The interior surface 134 may be laced with a diluted (or powdered) form of one or more insecticides, so that when insect 102 such as a yellowjacket enters the bait station 100, even if it does not grab food it will rub its body against the insecticide and bring that back into the nest, resulting in a transfer of the insecticide to the nest regardless of whether insect 102 takes bait 120 out. In other words, a bait station 100 of the present invention may include insecticide in the bait 120 as well as insecticide pre-coated on the inside of the housing 110, so that as insects 102 therein fly their wings and thorax and legs get contaminated with slow-acting insecticide (such as Fipronil).

This may be accomplished in using an applicator, for example a cotton swab or a spray bottle, that applies a diluted version of an insecticide such as Fipronil or Esfenvalerate to all the inside surfaces 134 of housing 110 comprising the bait station 100. This may also be accomplished by dipping the housing 110 into an insecticide wash and then sanitizing or removing the insecticide from the outside of the housing 110. It may also be accomplished by applying insecticide-laced adhesive fabric or paper to the inside surface 134 of the housing 110.

In another embodiment of the present invention, the housing 110 may be comprised of an outer container and inner container, where the inner container fits neatly inside of the outer container. The outer container is not laced with insecticide, but the inner container may be prepared by washing in an insecticide bath, and may also contain pre-mixed bait 120 therein.

Other embodiments of the present invention are configured in particular ways so as much insecticide as possible is deposited onto the bodies, wings, thoraxes, or exoskeletons of insects 102. These embodiments make it hard, but not impossible, for insects 102 such as yellowjackets to exit so that they remain inside the bait station 100 for as long as possible, all the while rubbing against walls and other obstacles configured inside the housing 110, resulting in further contamination of themselves by the bait station 100.

In one such configuration, tubes are attached to the apertures or holes 152 leading into the housing 110, so that insects 102 have a harder time exiting the bait station 100 once inside. These tubes may themselves be laced with pesticides like Esfenvalerate or Fipronil to add increased surface area and opportunities for contact with insects 102 as they enter and exit the bait station 100. These tubes may have particular shapes, for example a conical shape that is smaller on an inner end inside of the housing 110, than on the outer end towards an aperture or hole 152, to make it even more difficult for an insect to exit the bait station 100.

In another configuration, the housing 110 includes a container comprised of two or more different departments each having apertures or holes 152 for entrance or exit. In one example of this embodiment, the container is split into two compartments 170 and 172, a top compartment and a bottom compartment (or, left and right compartments 170 and 172, depending on the configuration). In the top or exterior compartment, there are one or more places for insects 102 to enter from the outside, and one or more places for the insects 102 to get into the bottom or interior compartment. The bait 120 is located in the bottom compartment, and the insects 102 must travel from the exterior compartment to the interior compartment to access the bait 120. One or more of these compartments 170 and 172 are laced with insecticide, resulting in the insects 102 getting more of the poison onto their bodies. The compartments 170 and 172 may be separated by a divider(s) 132 as shown in FIG. 7, and the divider 132 may likewise by laced with insecticide and/or insecticide residue.

In still another configuration, the housing 110 may include a maze of tubes that insects 102 have to traverse to get to the bait 120, and again to get out of the bait station 100. Such a maze of tubes may be laced with insecticide on their interior surfaces 134, so that the insects 102 come into contact with as much of the insecticide as possible on their way in and out of the bait station 100.

In another embodiment, the bait station 100 is configured as a pre-packaged, do-it-yourself kit. Currently a user must find a protein-based-bait, separately buy the insecticide, measure out the appropriate amounts, mix them all together, and place it directly into a container. This embodiment of the present invention is to pre-mix the bait 120 together with the insecticide before sealing it inside the housing 110, so that it can be preserved and used later. One configuration of such an embodiment is pre- packaged container having insecticide-laced bait 120 inside it, where the container is sealed for example with foil-covered paper, foil, or plastic packaging (or another like material that is capable of retaining moisture therein). The user opens the sealed packaging material when ready to deploy the bait station 100, places it into or attaches it to a container with one or more apertures for insect entry/egress and position the bait station 100 at the desired location.

Such a pre-packaged bait station 100 may include, as in other embodiments, a solution comprised of a protein-based bait 120 mixed with the appropriate amount of slow-acting insecticide. The pre-packaged bait solution may already be inside the housing 110, or may be provided separately in an openable package, container or pouch. Alternatively, the bait station 100 may include a drawer or port, whereby a door on the side of the bait station 100 can be opened, allowing the pre-packaged bait solution (openable in a separate package, container or pouch) to be placed inside the housing 110 without having to open the top ingress and egress receptacle 150. The drawer or port may further include a small blade attached thereto, whereby when a door on a side of the bait station 100 is opened, the pre-packaged bait solution is placed therein and the package or pouch is automatically opened so as not to contaminate a user with the insecticide. The drawer or port allows users to easily slide bait in and out of the bait station 100.

The present invention may also be configured as a pre-packaged bait container having a “soft” top that is opened by blade or sharp point when the bait container is coupled to another portion, for example the ingress and egress receptacle 150, to complete the bait station 100. Such a blade or sharp point may therefore be a part of the ingress and egress receptacle 150, for example on an inner portion thereof or as part of its thread system. Additionally, the pre-packaged bait container may form the bottom vessel 130 of the housing 110. It is to be understood that the pre-packaged bait container may include multiple, different types of protein baits 120 each mixed with a slow-acting insecticide and separated in the container by one or more dividers, allowing different varieties of insects 102 to be placed with poison in the same bait station 100 at the same time. In a further embodiment, the housing 110 may be configured with one or more blades and a timing system that mixes pre-packaged bait ingredients within the bait station 100 at a desired time.

Regardless, the bait station 100 having a pre-packaged bait container inside the housing 110 may include a cover, a tab on the outside and connected to the cover, and a small slit. Pulling the tab on the outside of the bait station 100 removes the cover from the pre-packaged bait container, thereby making the bait 120 available to the insects 102 inside the housing 110.

The bait station 100 may also be configured so that pre-packaged bait container is pre-attached as the bottom vessel 130, or may be a separate component that attaches to the top ingress and egress receptacle 150. Where this is the case, the user opens the bait container and then attaches it to the bait station 100. This may be accomplished, as suggested above, by snapping the pre-packaged bait container into the bottom of the ingress and egress receptacle 150 to complete the bait station 100, or by screwing the pre-packaged bait container into the bottom of the ingress and egress receptacle 150 to complete the bait station 100 or by placing it into a bait station 100 with existing holes for entry/egress. This may also be accomplished at some other point than at the bottom the ingress and egress receptacle 150.

Other embodiments of the present invention include timing and location devices, which at least in part serve as aids to the pest control industry. For example, pest control personnel often do not know how long a bait station has been deployed, as well as where a bait station is located. In one such embodiment, a bait station 100 is configured with a digital clock attached to an outside surface thereof. The clock acts as a stopwatch or timer, and may be set to begin counting up once the bait 120 has been placed into the bait station 100, or down from a pre-set time once the bait 120 has been placed into the bait station 100. In another embodiment, a beacon may be attached to a side of the bait station 100. The beacon connects to a mobile telephony device, tablet computer, laptop computer, or any other computing device that incorporate software tools such as mobile applications. Upon command from such an application or mobile computing device, the beacon provides an audible alert, notifying pest control personnel of its location. In still another embodiment, global position system (GPS) components may be configured with the bait station 100, which let mobile devices know where the bait station 100 is located. GPS data containing positional coordinates are transmitted from the bait station 100, enabling GPS receivers to determine the geographical location of the bait station 100.

In still another embodiment, infrared devices may be attached to one or more of the apertures and holes 152 of a bait station 100. Such infrared devices are configured to count the number of insects 102 that enter and exit the bait station 100. These counts may be transmitted to an application resident on a mobile computing device, or may be communicated over a wireless radio transmission link, for example via a Bluetooth® connection using a dongle or other device that is also configured with the bait station 100.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

1. A bait station for controlling populations of insects, comprising:
a bottom vessel, and an ingress and egress receptacle having at least one aperture, the ingress and egress receptacle being attachable to the bottom vessel to form a sealed housing configured to contain an insecticide-laced bait therein, the bottom vessel forming a base portion of the housing, and the ingress and egress receptacle forming a top portion of the housing, and the one or more aperture allowing both entry into the housing for insects to contact with and collect the insecticide-laced bait while inside the housing, and exit from the housing while remaining alive, wherein ingredients of the insecticide-laced bait are mixed and shaken together inside the housing to treat an interior surface of at least a portion of the housing with the insecticide-laced bait.

2. The bait station of claim 1, wherein the base portion and the top portion are sealed together to form the housing once the ingredients of the insecticide-laced bait is mixed with a liquid, placed in the base portion, and shaken together.

3. The bait station of claim 2, further comprising a mixing cap removably attachable to the bottom vessel to form a seal therebetween when the mixing cap is applied to the bottom vessel for the mixing the ingredients comprising the insecticide- laced bait.

4. The bait station of claim 1 where the ingredients are initially placed in the bottom vessel, and wherein the bottom vessel is inserted into a larger top portion having the at least one aperture upon shaking the bottom vessel to mix the ingredients.

5. The bait station of claim 1, where the ingredients are shaken and mixed within the housing, and at least one aperture is opened once the interior surface is treated with the insecticide-laced bait.

6. The bait station of claim 1, wherein the bottom vessel is comprised of one or more compartments, each having the insecticide-laced bait placed therein.

7. The bait station of claim 6, wherein a different insecticide-laced bait is placed in each of the one or more compartments to attract different types of insects.

8. The bait station of claim 1, wherein the insecticide-laced bait is treated with a chemical compound, the chemical compound comprised of at least one of Esfenvalerate and Fipronil.

9. The bait station of claim 1, wherein the insecticide-laced bait includes one or more of poultry, seafood, beef, lamb venison, or a synthetic protein.

10. The bait station of claim 1, wherein the insecticide-laced bait is mixed with water.

11. The bait station of claim 1, wherein the base portion and top portion form a pre-sealed housing, with the insecticide-laced bait placed therein.

12. The bait station of claim 1, wherein the at least one aperture is initially closed, and opened once the ingredients are shaken inside the housing and mixed together.

13. An apparatus, comprising:
a treated bait for attracting insects, the treated bait including at least an insecticide and a food ingredient;
a housing for containing the treated bait, the housing including a bottom portion and a top portion, the top portion having at least one aperture that allow both entry into the housing for insects to contact with and collect the treated bait while inside the housing, and exit from the housing while remaining alive, wherein the food ingredient is mixed with the insecticide within the housing thereto to form a bait station, and housing is shaken to treat the bait and coat an interior surface of the housing.

14. The apparatus of claim 13, wherein the bottom portion and the top portion are sealed together to form the housing once the treated bait is placed in the bottom portion.

15. The apparatus of claim 14, further comprising a mixing cap removably attachable to the bottom portion to form a seal therebetween when the mixing cap is applied to the bottom portion, for mixing the bait ingredients.

16. The apparatus of claim 13, wherein the insecticide and the food ingredient are initially placed in the bottom portion, and wherein the bottom portion is inserted into a larger top portion having the at least one aperture upon shaking the bottom portion to treat the bait.

17. The apparatus of claim 13, where the insecticide and the food ingredient are shaken and mixed within the housing, and at least one aperture in the top portion is opened once the interior surface is covered with the treated bait.

18. The apparatus of claim 13, wherein the bottom portion is comprised of one or more compartments, each having the bait placed therein.

19. The apparatus of claim 18, wherein a different type of bait is placed in each of the one or more compartments to attract different types of insects.

20. The apparatus of claim 13, wherein the insecticide includes at least one of Esfenvalerate and Fipronil.

21. The apparatus of claim 13, wherein the treated bait further includes a liquid.

22. The apparatus of claim 13, wherein the food ingredient includes one or more of poultry, seafood, beef, lamb, venison, or a synthetic protein.

23. The apparatus of claim 13, wherein the bottom portion and top portion form a pre-sealed housing, with the treated bait placed therein.

24. The apparatus of claim 13, wherein the at least one aperture is initially closed, and opened once the insecticide and the food ingredient are shaken inside the housing and mixed together.

25. A bait station for controlling populations of insects, comprising:
a bottom vessel;
an ingress and egress receptacle having at least one aperture, the ingress and egress receptacle and the bottom vessel forming a housing from which insects are able to enter and exit through the at least one aperture; and
a pre-packaged bait comprised at least of an insecticide and a food ingredient, wherein the pre-packaged, treated bait is inserted into the housing so that insects inside the housing come into contact with and collect the bait while inside the housing, and exit from the housing while remaining alive.
